(19) United States
(12) Patent Application Publication
(10) Pub. No.: US 2017/0343374 A1
(43) Pub. Date: Nov. 30, 2017

(54) VEHICLE NAVIGATION METHOD AND APPARATUS

(71) Applicant: Baidu Online Network Technology (Beijing) Co., Ltd., Beijing (CN)

(72) Inventors: Shichun YI, Beijing (CN); Tianlei ZHANG, Beijing (CN)

(21) Appl. No.: 15/282,683

(22) Filed: Sep. 30, 2016

(30) Foreign Application Priority Data
May 27, 2016 (CN) 201610365790.2

(51) Int. Cl. G01C 21/36; G01S 19/42; G01C 21/20; G06T 11/60; G06K 9/00

(52) U.S. Cl. CPC G01C 21/3632; G06T 11/60; G06K 9/00798; G01C 21/20; G01C 21/3676; G01C 21/3647; G01S 19/42

(57) ABSTRACT

The present application discloses a vehicle navigation method and apparatus. In some embodiments, the method includes: collecting a road condition image; deciding whether a lane currently traveled by a vehicle is a navigation lane; determining a lane object in the road condition image on which a guiding track object is to be superimposed and displayed, the guiding track object adapted to instruct the vehicle to travel along the lane currently traveled by the vehicle, or to instruct the vehicle to turn to the navigation lane; and superimposing and displaying the guiding track object on the determined lane object. According to the current vehicle position and the navigation route, by superimposing and displaying the guiding track object on the lane traveled by the vehicle, the driver is intuitively guided to drive the vehicle in the lane where the vehicle should be driven, thus navigating the vehicle more accurately.

### CROSS-REFERENCE TO RELATED APPLICATIONS

This application claims priority of Chinese Patent Application No. 201610365790.2, entitled “VEHICLE NAVIGATION METHOD AND APPARATUS”, filed on May 27, 2016 in the State Intellectual Property Office (SIPO) of China, the contents of which are herein incorporated by reference in their entirety.

### TECHNICAL FIELD

The present application relates to the field of computers, specifically to the field of navigation, and more specifically to a vehicle navigation method and apparatus.

### BACKGROUND

With extensive application of computer technologies in vehicles, the vehicles become increasingly intelligent. Vehicle navigation is one of the functions most commonly used when driving a vehicle. A conventional vehicle navigation mode at present includes: a navigation route is determined after inputting an origin and a destination; and navigation approaches include displaying the navigation route or voice broadcast etc.

However, when navigation is conducted in the above manner, the navigation information, on one hand, only includes the navigation route, which has a comparatively rough granularity, fine granularity navigation information, for example, where the vehicle should be driven on the correct lane of a given road section, cannot be provided. As a result, the driver still needs to mentally judge the lane where the vehicle should be driven in order to arrive at the destination. On the other hand, through voice broadcast, it is impossible to intuitively present the driver with the correct lane where the vehicle should be driven, resulting in the need that the driver attentively observes road conditions and performs proper operations according to the broadcast content.

### SUMMARY

Some embodiments of the present application provide a vehicle navigation method and apparatus, so as to solve the technical problems mentioned in the above BACKGROUND.

In a first aspect, some embodiments of the present application provide a vehicle navigation method, including: collecting a road condition image through a camera; deciding whether a lane currently traveled by a vehicle is a navigation lane, the navigation lane being a recommended driving lane as defined in navigation information; determining, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and superimposing and displaying the guiding track object on the determined lane object.

In a second aspect, some embodiments of the present application provide a vehicle navigation apparatus, including: a collection unit configured to collect a road condition image through a camera; a decision unit configured to decide whether a lane currently traveled by a vehicle is a navigation lane, the navigation lane being a recommended driving lane as defined in navigation information; a determination unit configured to determine, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and a superimposition unit configured to superimpose and display the guiding track object on the determined lane object.

According to the vehicle navigation method and apparatus provided in some embodiments of the present application, a road condition image is collected through a camera; it is decided whether a lane currently traveled by a vehicle is a navigation lane, the navigation lane being a recommended driving lane as defined in navigation information; a lane object in the road condition image on which a guiding track object is to be superimposed and displayed is determined based on a result of the deciding, the guiding track object adapted to instruct the vehicle to travel along the lane currently traveled by the vehicle, or to instruct the vehicle to turn to the navigation lane; and the guiding track object are superimposed and displayed on the determined lane object. According to the current vehicle position and the navigation route, by superimposing and displaying the guiding track object on the lane traveled by the vehicle, the driver is intuitively guided to drive the vehicle in the lane where the vehicle should be driven, thus navigating the vehicle more accurately.

### BRIEF DESCRIPTION OF THE DRAWINGS

Other features, objectives and advantages of the present application will become more evident by reading the detailed description to non-limiting embodiments with reference to the accompanying drawings, wherein

FIG. 1 is a architectural diagram of an system in which some embodiments of the present application can be implemented;

FIG. 2 is a flow chart of a vehicle navigation method according to an embodiment of the present application;

FIG. 3 is a schematic effect diagram showing lane lines in a road condition image being projected to the ground according to some embodiments of the present application;

FIG. 4 is a schematic effect diagram of a high precision map;

FIG. 5 is a principle diagram of a vehicle navigation method according to some embodiments of the present application;

FIG. 6 is a schematic effect diagram in which a guiding track object is superimposed and displayed according to some embodiments of the present application;

FIG. 7 is another schematic effect diagram in which a guiding track object is superimposed and displayed according to some embodiments of the present application;

FIG. 8A is a real diagram of a road condition image in which a guiding track object is superimposed and displayed according to some embodiments of the present application;

FIG. 8B is another real diagram of a road condition image in which a guiding track object is superimposed and displayed according to some embodiments of the present application;

FIG. 9 is a schematic structural diagram of a vehicle navigation apparatus according to an embodiment of the present application; and

FIG. 10 is a schematic structural diagram of a computer system adapted to implement a vehicle navigation apparatus according to an embodiment of the present application.

### DETAILED DESCRIPTION OF EMBODIMENTS

The present application will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

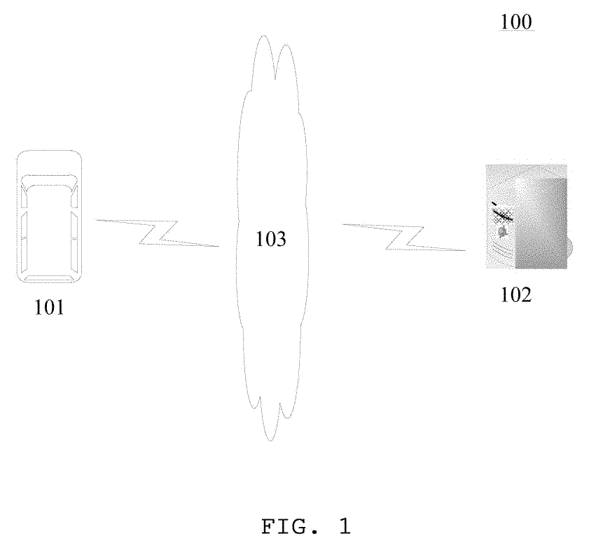

FIG. 1 illustrates a system architecture 100 to which embodiments of a vehicle navigation method and apparatus of some embodiments of the present application can be implemented.

As shown in FIG. 1, the system architecture 100 may include a vehicle (for example, an driverless vehicle) 101, a network 103 and a server (for example, a cloud server) 102. The network 103 is used to provide a link transmission medium between the vehicle 101 and the server 102. The network 103 may be a wireless transmission link.

The vehicle 101 may be provided with a voice recognition device which is configured to receive a voice instruction inputted by a user of the vehicle, for example, the vehicle driver or a passenger in the vehicle. The vehicle is then controlled to perform an operation corresponding to the voice instruction. The vehicle 101 may be provided with a GPS chip configured to determine the current position of the vehicle. The vehicle 101 may be provided with sensors deployed inside or outside, for example, a speed sensor, an angle sensor and a crash sensor, and a bus, for example, a Controller Area Network (CAN) bus, configured to transmit data of the sensors.

The server 102 may store a high precision map in which positions of objects such as lane lines, stop lines and traffic diversion lines of different road sections are labeled. The server 102 may receive a navigation request sent from the vehicle 101, and feed back positions of the lane line, the stop line and the traffic diversion line of the road section currently traveled by the vehicle 101, labeled in the high precision map to the vehicle 101.

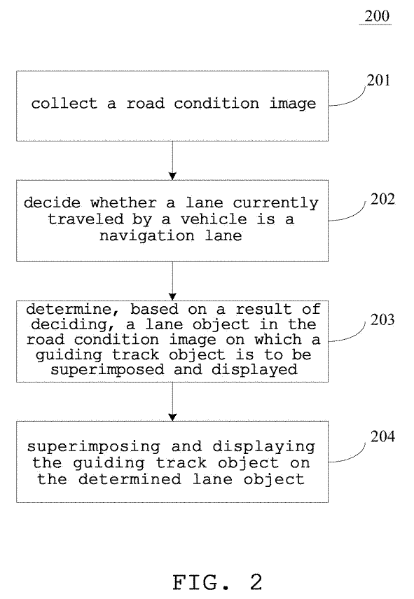

Referring to FIG. 2, a process 200 of a vehicle navigation method according to an embodiment of the present application is illustrated. It should be noted that the vehicle navigation method provided in the embodiment of the present application may be performed by the vehicle 101 in FIG. 1, and correspondingly, the vehicle navigation apparatus may be arranged in the vehicle 101. The method includes the following steps:

Step 201, collecting a road condition image.

In this embodiment, the road condition image in the course of vehicle traveling may be collected in real time through a camera arranged on the vehicle. The road condition image includes a lane object corresponding to a lane of a road section currently traveled by the vehicle.

Step 202, deciding whether the lane currently traveled by the vehicle is a navigation lane.

In this embodiment, after the road condition image in the course of vehicle traveling is collected in real time in step 201, the lane traveled by the vehicle may be determined, and then whether the lane traveled by the vehicle is the navigation lane may be decided, wherein the navigation lane is a recommended lane driving and is defined in the navigation information.

In some alternative implementations of this embodiment, the method further includes: generating the navigation information which includes: a navigation route, signs of road sections on the navigation route and lanes corresponding to preset operations on the road sections, the preset operations including: a straight-going operation, a turn operation and a turn-around operation.

In this embodiment, the navigation information may be pre-generated before deciding whether the lane currently traveled by the vehicle is the navigation lane. The navigation information may include the navigation route that indicates a path of the vehicle from a starting point to a destination. The navigation information may further include the sign of each road section in the navigation route and the sign of the lane where the vehicle should travel when the vehicle performs operations such as the straight-going operation, the turn operation and the turn-around operation in the case of traveling on each road section, that is, the sign of the navigation lane.

By taking two adjacent road sections in the navigation route as an example, according to the navigation route, when the vehicle is driven from the previous road section in the two adjacent road sections into the last road section, the vehicle needs to turn. The vehicle needs to travel from a turn lane (for example, a left turn lane or a right turn lane) of the previous road section to the last road section. At this point, the navigation information may include a sign of the previous road section and a sign of the last road section. The navigation information includes a sign of a lane on the previous road section corresponding to the turn operation to be performed. Thus, when the vehicle travels on the previous road section according to the navigation route, it may be determined, according to the sign of the lane corresponding to the turn operation in the navigation information, that the vehicle needs to travel on a lane corresponding to the sign, such that the vehicle can complete the turn operation, travel into the last road section and travel according to a route specified in the navigation route.

In some alternative embodiments of this embodiment, deciding whether the lane currently traveled by the vehicle is the navigation lane includes: determining a position of the vehicle; acquiring, from the high precision map, a position of a lane line of a road section corresponding to the position of the vehicle; determining the lane currently traveled by the vehicle based on the position of the vehicle and the position of the lane line; and deciding whether the lane currently traveled by the vehicle is the navigation lane.

In this embodiment, in the deciding whether the lane currently traveled by the vehicle being the navigation lane, a position of the vehicle in the road currently traveled by the vehicle may be determined first, and after the position of the vehicle is determined, the lane where the vehicle is located may be decided in combination with the high precision map.

In some alternative embodiments of this embodiment, determining the position of the vehicle includes: acquiring a GPS coordinate corresponding to the position of the vehicle; projecting a lane line in the road condition image to the ground; taking a distance between the lane line projected to the ground and the lane line in the high precision map as a measurement error; calculating a probability distribution of the position of the vehicle by using a Kalman Filtering algorithm based on the GPS coordinate, the measurement error and a preset vehicle motion model; and determining a position corresponding to the maximum probability as the position of the vehicle.

In some alternative embodiments of this embodiment, projecting the lane line in the road condition image to the ground includes: identifying the lane line in the road condition image through machine learning; extracting the identified lane line; and projecting the extracted lane line to the ground through sectional straight line fitting.

In this embodiment, the lane line in the road condition image may be identified through machine learning, for example, through a deep learning model, and then the identified lane line may be extracted and then projected to the ground through sectional straight line fitting.

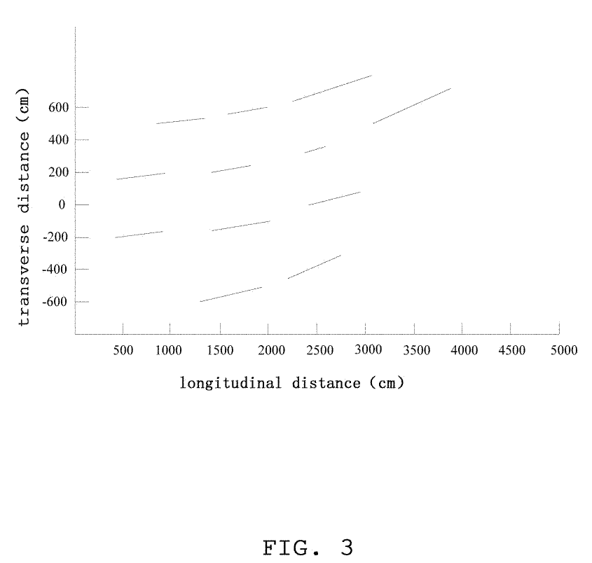

Referring to FIG. 3, a schematic effect diagram showing lane lines in a road condition image being projected to the ground is illustrated.

In this embodiment, the position of the vehicle may be determined in the following manner: an accurate position of the vehicle may be calculated in real time through a Kalman Filtering (EKF) algorithm. A motion model of the vehicle may be used as a state equation when the position of the vehicle is calculated through the EKF algorithm.

In this embodiment, the motion model of the vehicle may be simplified into three degrees of freedom, and three parameters x, y and φ may be employed to describe the state of the vehicle. x and y may denote the position of the vehicle in a horizontal direction and in a vertical direction, φ may denote a heading angle of the vehicle, and the motion model of the vehicle may be denoted as:

$${x}_{k + 1} = [ \begin{matrix}{x}_{k} + v \cdot Δ t \cdot cos ( {ϕ}_{k} + ω \cdot Δ t ) \\ {y}_{k} + v \cdot Δ t \cdot sin ( {ϕ}_{k} + ω \cdot Δ t ) \\ {ϕ}_{k} + ω \cdot Δ t\end{matrix} ]$$

wherein xₖ₊₁ denotes a matrix formed by values of x, y and φ when the vehicle is at the time of k+Δt. xₖ, yₖ and φₖ may denote values of x, y and φ at the time of k. ν may denote a traveling speed of the vehicle, ω may denote a yaw angle of the vehicle, and ν and ω may be measured through a wheel speed meter and a gyroscope.

In this embodiment, a lane object in the collected road condition image may be extracted. For example, the lane object in the road condition image may be identified through a deep learning model. Then, the lane object in the road condition image is extracted. After the lane object is extracted, the extracted lane object may be projected to the ground through sectional straight line fitting.

In this embodiment, after the lane object is projected to the ground, the distance between the lane line projected to the ground and the lane line labeled in the high precision map may be taken as the measurement error when the position of the vehicle is calculated through the EKF algorithm; at the same time, a vehicle position obtained through a GPS, that is, a GPS coordinate of the vehicle position, may be taken as an initial value. Thus, according to the EKF algorithm, it is feasible to calculate the probability distribution of the position of the vehicle based on the above state equation, the measurement error and the initial value and determine the position of the vehicle, for example, a position corresponding to the maximum probability may be selected as the position of the vehicle, thus achieving real-time vehicle positioning.

In this embodiment, after the current position of the vehicle is determined, the lane currently traveled by the vehicle may be further decided in combination with the high precision map.

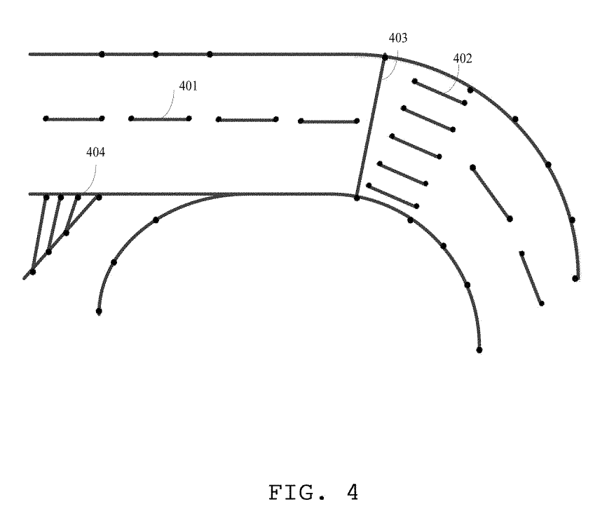

Referring to FIG. 4, a schematic effect diagram of the high precision map is illustrated.

In FIG. 4, a lane line 401, a zebra crossing 402, a stop line 403 and a traffic diversion line 404 in the high precision map are illustrated. In the high precision map, positions of objects such as the lane line, the zebra crossing, the stop line and the traffic diversion line may be labeled according to coordinates of multiple points on the collected objects such as the lane line, the zebra crossing, the stop line and the traffic diversion line. Lane parameters and a parameter equation of each lane line are recorded in the high precision map. The lane parameters may include the number of lanes, positions of lane lines and lane attributes, for example, a straight-going lane, a turn lane and other lane attributes.

In this embodiment, the lane where the vehicle is currently located may be determined according to the position of the vehicle and the positions of the lane lines labeled in the high precision map as well as the parameter equation of the lane lines. For example, between which two lane lines the position of the vehicle is located may be decided according to the positions of the lane lines labeled in the high precision map, and then the lane where the vehicle is currently located is further decided.

Step 203, determining, based on a result of the deciding, a lane object in the road condition image on which a guiding track object needs to be superimposed and displayed.

In this embodiment, the guiding track object is used to instruct the vehicle to travel along the current lane or instruct the vehicle to turn to the navigation lane. In this embodiment, after whether the lane currently traveled by the vehicle is the navigation lane is decided in step 202, the decision result may be obtained. For example, the vehicle should continue going straight in the current lane or should turn to another lane. The lane object in the road condition image on which the guiding track object needs to be superimposed and displayed may be further determined based on the result of the deciding.

In some alternative implementations of this embodiment, determining, based on the result of the deciding, the lane object in the road condition image on which the guiding track object needs to be superimposed and displayed includes: determining a lane object in the road condition image corresponding to the lane currently traveled by the vehicle as the lane object on which the guiding track object needs to be superimposed and displayed when the result of the deciding is that the lane currently traveled by the vehicle is the navigation lane; and determining the lane object in the road condition image corresponding to the lane currently traveled by the vehicle and a lane object corresponding to the navigation lane as the lane object on which the guiding track object needs to be superimposed and displayed when the result of the deciding is that the lane currently traveled by the vehicle is not the navigation lane.

In this embodiment, when the result of the deciding is that the lane currently traveled by the vehicle is the navigation lane, the lane object in the road condition image corresponding to the lane currently traveled by the vehicle may be taken as the lane object on which the guiding tracks object needs to be superimposed and displayed. When the result of the deciding is that the lane currently traveled by the vehicle is not the navigation lane, the lane object in the road condition image corresponding to the lane currently traveled by the vehicle and the lane object corresponding to the navigation lane may be taken as the lane object on which the guiding track object needs to be superimposed and displayed.

Step 204, superimposing and displaying the guiding track object on the determined lane object.

In this embodiment, after the lane object in the road condition image on which the guiding track object needs to be superimposed and displayed is determined based on the result of the deciding on whether the lane currently traveled by the vehicle being the navigation lane in step 203, the guiding track object may be superimposed and displayed on the determined lane object.

For example, in step 203, when the result of the deciding on whether the lane currently traveled by the vehicle being the navigation lane is that the lane currently traveled by the vehicle is the navigation lane, a guiding track object, which instructs the vehicle to continuously travel along the current lane, may be superimposed and displayed on the lane object in the road condition image corresponding to the lane currently traveled by the vehicle. In step 203, when the result of the deciding on whether the lane currently traveled by the vehicle being the navigation lane is that the lane currently traveled by the vehicle is not the navigation lane, a guiding track object, which points to the navigation lane where the vehicle should turn to, may be superimposed and displayed on the lane object in the road condition image corresponding to the lane currently traveled by the vehicle, and a guiding track object, which instructs the vehicle to continuously travel on the navigation lane, may be displayed on the lane object in the road condition image corresponding to the navigation lane.

In this embodiment, the guiding track object may be projected into the road condition image through transformation relations among a geodetic coordinate system, a vehicle coordinate system, a camera coordinate system and an image coordinate system, thus achieving superimposition of the guiding track object in the road condition image through texture mapping. For example, the guiding track object is superimposed and displayed in the center of the current lane in the road condition image. Thus, the corresponding guiding track object is superimposed and displayed in real time in the road condition image collected through the camera, the driver is guided to drive the vehicle on the correct lane more accurately, and driving assistance is effectively provided.

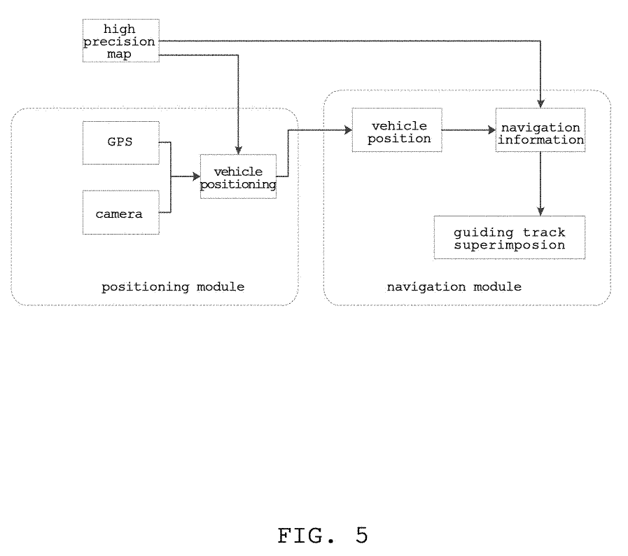

Referring to FIG. 5, a principle diagram of a vehicle navigation method according to some embodiments of the present application is illustrated.

In FIG. 5, a positioning module and a navigation module are illustrated. The positioning module includes a GPS and a camera. Vehicle positioning may be implemented through the positioning module to obtain the position of the vehicle. The navigation module may, on the basis of the position of the vehicle, decide whether the lane currently traveled by the vehicle is the recommended driving lane, based on a sign of the lane where the vehicle should be driven, that is, the sign of the navigation lane, in the high precision map and the navigation information when the vehicle performs operations such as a straight-going operation, a turn operation and a turn-around operation in the case of traveling on each road section. The guiding track object superimposed and displayed on the corresponding lane in the road condition image may be determined according to the result of the deciding. Thus, the corresponding guiding track object is superimposed and displayed in real time in the road condition image collected through the camera, thereby more accurately guiding the driver to be driven on the correct lane and effectively providing driving assistance.

The vehicle navigation method in some embodiments of the present application is illustrated below. In this embodiment, the above navigation module may be used to first query road information of the road section currently traveled by the vehicle in the high precision map according to the current traveling position of the vehicle and, through comparison with the navigation route, decide whether the current travel lane is reasonable. Intersections, entrances and exits of respective road sections in the navigation route may be defined in the navigation information, and the intersections, the entrances and the exits are taken as road nodes. The navigation information may record that the vehicle needs to perform straight-going, turn, turn-around and other operations at the road nodes, and the vehicle that performs straight-going, turn, turn-around and other operations at the road nodes should be driven in the correct lane, to avoid violation of traffic rules. If a distance from the vehicle to the next road node exceeds a set length, for example, 500 m, the vehicle may be driven in any lane, and the guiding track object that instructs the vehicle to be driven in the lane currently traveled by the vehicle is superimposed and displayed on the lane object corresponding to the current lane in the road condition image, for example, guide lines. If the distance from the vehicle to the next road node is less than the set length, it is necessary to make decision according to the driving requirement of the vehicle at the next road node.

If the attribute of the current lane meets the driving requirement, for example, the vehicle needs to turn left at the next road node, and the current lane is just a left turn lane, guide lines that keep the vehicle traveling on the lane are also superimposed in the road condition image. If the attribute of the current lane does not meet the driving requirement, the guiding track object used to point at a lane changing direction, for example, guide lines, is superimposed and displayed in the center of the current lane in the image. The guiding track object instructing the vehicle to continuously travel in the current driving lane, for example, guide lines, is superimposed and displayed in the nearest correct lane.

Referring to FIG. 6, a schematic effect diagram in which the guiding track object is illustrated.

In FIG. 6, a road condition image 600, a vehicle object 601, a guiding track object 602 superimposed in the road condition image and an intersection object 603 are illustrated. The guiding track object 602 are represented with arrow-like guide lines. When the vehicle, as defined in the navigation route in the navigation information, is driven in the current driving road section, the vehicle needs to turn right in a road node corresponding to the intersection object 603. A lane where the vehicle corresponding to the vehicle object 601 is traveling is a right turn lane where the vehicle can turn right. The lane is the navigation lane, that is, the recommended driving lane of the vehicle, and the guiding track object 602 superimposed and displayed in the road condition image is the guiding track object that instructs the vehicle corresponding to the vehicle object 601 to continuously travel on the lane.

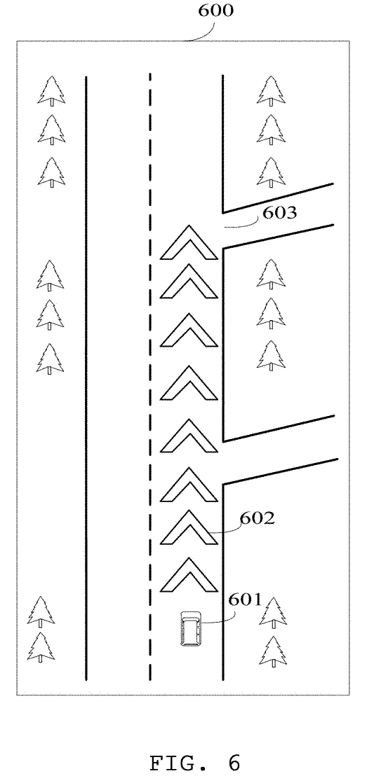

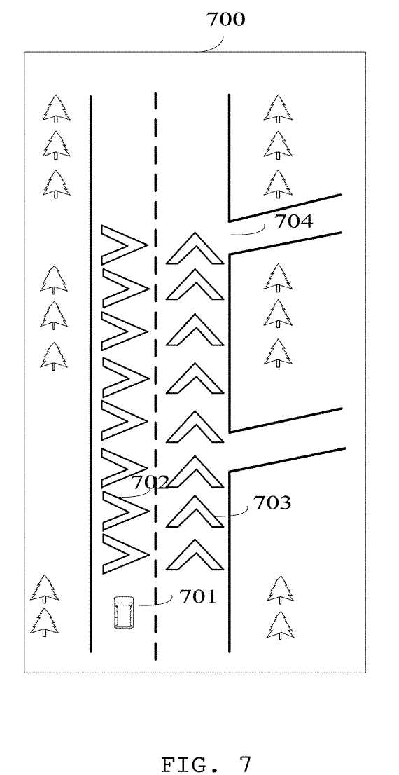

Referring to FIG. 7, another schematic effect diagram in which the guiding locus object is superimposed and displayed is illustrated.

In FIG. 7, a road condition image 700, a vehicle object 701, a guiding track object 702 superimposed on a lane object in the road condition image corresponding to a lane currently traveled by the vehicle, a guiding track object 703 superimposed on a lane object in the road condition image corresponding to a lane on the right of the lane currently traveled by the vehicle, and an intersection object 704 are illustrated. The guiding track object 702 and the guiding track object 703 are represented with arrow-like guide lines. When it is defined in the navigation route in the navigation information that the vehicle is driven in the current driving road section, the vehicle needs to turn right at an intersection corresponding to the intersection object 704. The lane on the right of the lane currently traveled by the vehicle is a right turn lane where the vehicle can turn right. At this point, the navigation lane corresponding to the vehicle corresponding to the vehicle object 701 is the lane on the right of the lane currently traveled by the vehicle. The guiding track object 702 is the guiding track object indicating that the vehicle corresponding to the vehicle object 701 should turn to the right of the lane currently traveled by the vehicle. The guiding track object 703 is the guiding track object indicating a lane where the vehicle corresponding to the vehicle object 701 should travel.

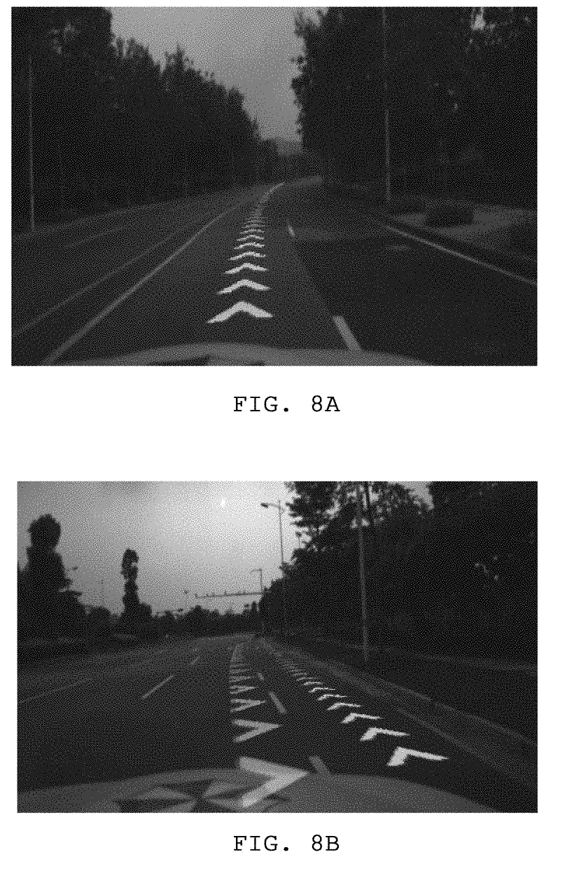

Referring to FIG. 8A, a real diagram of a road condition image in which a guiding track object is superimposed and displayed is illustrated.

In FIG. 8A, a road condition image where a guiding track object is superimposed and displayed is illustrated. The road condition image includes a lane line in a road section currently traveled by the vehicle, and a guiding track object superimposed and displayed on the current driving lane, wherein the guiding track object is represented with arrow-like guide lines. The lane currently traveled by the vehicle as defined in the navigation route in the navigation information is the recommended driving lane for the vehicle, and the guiding track object superimposed and displayed on the lane in the road condition image currently traveled by the vehicle is the guiding track object instructing the vehicle to continuously travel on the lane.

Referring to FIG. 8B, another real diagram of a road condition image in which a guiding track object is superimposed and displayed is illustrated.

In FIG. 8B, a road condition image after guiding track objects are superimposed and displayed is illustrated. The road condition image includes a lane line in a road section currently traveled by the vehicle, and guiding track objects superimposed on the lane line. A lane where the vehicle should be driven as defined in the navigation route in the navigation information is a lane on the right of the lane currently traveled by the vehicle. At this point, the guiding track object superimposed and displayed on the lane in the road condition image currently traveled by the vehicle is the guiding track object instructing the vehicle to turn to the right lane, that is, arrow-like guide lines pointing to a lane on the right of the lane currently traveled by the vehicle. The guiding track object superimposed and displayed on the lane on the right of the lane in the road condition image currently traveled by the vehicle is the guiding track object indicating the lane where the vehicle should be driven, that is, arrow-like guide lines in the lane on the right of the lane currently traveled by the vehicle.

In some alternative implementations of this embodiment, superimposing and displaying the guiding track object on the determined lane object includes: determining a position of a guiding track corresponding to the guiding track object in the geodetic coordinate system; determining positions of the guiding track object in the road condition image based on the position and transformation relations among the geodetic coordinate system, the vehicle coordinate system, the camera coordinate system and the image coordinate system; and rendering the guiding track object on the determined position through texture mapping.

In this embodiment, the position of the guiding track corresponding to the guiding track object in the geodetic coordinate system may be determined first. For example, a center point of the guiding track may be overlapped with a center position of the lane corresponding to the lane object where the guiding track object are superimposed and displayed, and then the position of the guiding track may be determined according to the high precision map and a preset width corresponding to the guiding track. For example, positions of respective points on the contour of the guiding track may be determined.

After the position of the guiding track corresponding to the guiding track object in the geodetic coordinate system is determined, position of the guiding track object in the road condition image may be determined through transformation relations among the geodetic coordinate system, the vehicle coordinate system, the camera coordinate system and the image coordinate system. For example, positions of respective points on the contour of the guiding track object in the road condition image are determined. Then, the guiding track object may be rendered on the determined position through texture mapping. For example, the guiding track object is superimposed and displayed in the center of the lane object in the road condition image.

A process of superimposing and displaying a guiding track based on the geodetic coordinate system in the collected road condition image through the transformation relations among the geodetic coordinate system, the vehicle coordinate system, the camera coordinate system and the image coordinate system is illustrated through an example below:

A positioning state of the vehicle at the time k may be represented with xₖ, yₖ and φₖ, wherein xₖ and yₖ denote positions of the vehicle in the horizontal direction and the vertical direction, respectively, in the geodetic coordinate system at the time k, and φₖ denotes a heading angle of the vehicle in the geodetic coordinate system at the time k. The transformation relation between the geodetic coordinate system corresponding to the high precision map and the vehicle coordinate system may be represented as:

$$[ \begin{matrix}{x}_{v} \\ {y}_{v}\end{matrix} ] = [ \begin{matrix}cos ( {ϕ}_{k} ) & sin ( {ϕ}_{k} ) \\ - sin ( {ϕ}_{k} ) & cos ( {ϕ}_{k} )\end{matrix} ] [ \begin{matrix}{x}_{w} - {x}_{k} \\ {y}_{w} - {y}_{k}\end{matrix} ]$$

wherein xᵥ and yᵥ denote the positions of the vehicle in the horizontal direction and the vertical direction, respectively, in the vehicle coordinate system at the time k. x_{w} and y_{w} may denote positions of a point in one object (for example, a guiding track object), for example, a point on the contour of the guiding track object, in a horizontal direction and a vertical direction, respectively, in the geodetic coordinate system.

The transformation relation [R|T] between the vehicle coordinate system and the camera coordinate system may be obtained through system calibration, and may be represented as:

$$[ \begin{matrix}{x}_{c} \\ {y}_{c} \\ {z}_{c}\end{matrix} ] = [ R \vert T ] [ \begin{matrix}{x}_{v} \\ {y}_{v} \\ 1\end{matrix} ]$$

x_{c}, y_{c} and z_{c} may denote corresponding positions of a point in one object (for example, a guiding track object) on X axis, Y axis and Z axis, respectively, in the camera coordinate system. R and T may denote rotation and translation matrixes respectively.

The transformation relation between the camera coordinate system and the image coordinate system may be determined according to internal parameters of the camera, and may be represented as:

$$[ \begin{matrix}u \\ v \\ 1\end{matrix} ] = [ \begin{matrix}{c}_{x} & 0 & {u}_{c} \\ 0 & {c}_{y} & {v}_{c} \\ 0 & 0 & 1\end{matrix} ] [ \begin{matrix}{x}_{c} / {z}_{c} \\ {y}_{c} / {z}_{c} \\ 1\end{matrix} ]$$

u and v may represent the position of one point in the image. u_{c} and v_{c} may represent the position of the origin of the camera in the image coordinate system, and cₓ and c_{y} may represent the quotient of the focal length of the camera and sizes of each unit in a sensor in directions of x and y coordinate axes of the image coordinate system.

In this embodiment, the position of the guiding track object in the road condition image may be determined based on the transformation relations among the geodetic coordinate system, the vehicle coordinate system, the camera coordinate system and the image coordinate system, and the guiding track object is rendered on the determined position through texture mapping. For example, the guiding track object is superimposed and displayed in the center of the lane object in the road condition image, so that the guiding track object is superimposed and displayed in the road condition image.

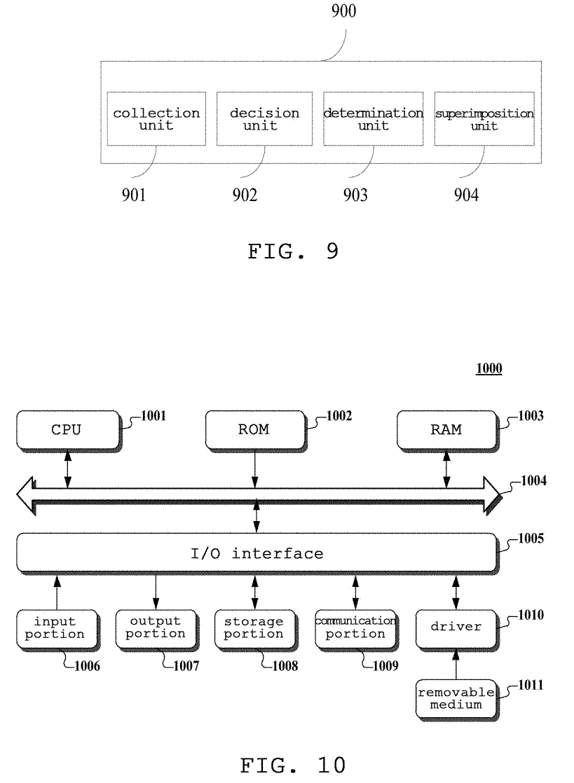

Referring to FIG. 9, as an implementation for the method shown in the above figures, some embodiments of the present application provide a vehicle navigation apparatus according to an embodiment, the apparatus embodiment corresponds to the method embodiment shown in FIG. 2, and the vehicle navigation apparatus may be mounted in a vehicle.

As shown in FIG. 9, a vehicle navigation apparatus 900 of this embodiment includes: a collection unit 901, a decision unit 902, a determination unit 903 and a superimposition unit 904. The collection unit 901 is configured to collect a road condition image through a camera; the decision unit 902 is configured to decide whether a lane currently traveled by the vehicle is a navigation lane, the navigation lane being a lane where the vehicle should be driven defined in the navigation information; the determination unit 903 is configured to determine, based on a result of the deciding, a lane object in the road condition image on which a guiding track object needs to be superimposed and displayed, the guiding track object being used to instruct the vehicle to travel according to the current driving lane or instruct the vehicle to turn to the navigation lane; and the superimposition unit 904 is configured to superimpose and display the guiding track object on the determined lane object.

In some alternative implementations of this embodiment, the decision unit 902 includes: a position determination subunit (not shown) configured to determine a position of the vehicle; a lane line position acquisition subunit (not shown) configured to acquire, from a high precision map, a position of a lane line of a road section where the position of the vehicle is located; a lane determination subunit (not shown) configured to determine the lane currently traveled by the vehicle based on the position of the vehicle and the position of the lane line; and a navigation lane decision subunit (not shown) configured to decide whether the lane currently traveled by the vehicle is the navigation lane.

In some alternative implementations of this embodiment, the position determination subunit includes: a coordinate acquisition module (not shown) configured to acquire a GPS coordinate corresponding to the position of the vehicle; a projection module (not shown) configured to project a lane line in the road condition image to the ground; an error determination module (not shown) configured to take a distance between the lane line projected to the ground and the lane line in the high precision map as a measurement error; and a calculation module (not shown) configured to calculate probability distribution of the position of the vehicle by using a Kalman Filtering algorithm based on the GPS coordinate, the measurement error and a preset vehicle motion model; and determine a position corresponding to the maximum probability as the position of the vehicle.

In some alternative implementations of this embodiment, the projection module is further configured to: identify the lane line in the road condition image through machine learning; extract the identified lane line; and project the extracted lane line to the ground through sectional straight line fitting.

In some alternative implementations of this embodiment, the determination unit 903 includes: a first lane object determination subunit (not shown) configured to determine a lane object in the road condition image corresponding to the lane currently traveled by the vehicle as the lane object on which a guiding track object needs to be superimposed and displayed when the result of the deciding is that the lane currently traveled by the vehicle is the navigation lane; and a second lane object determination subunit (not shown) configured to determine a lane object in the road condition image corresponding to the lane currently traveled by the vehicle and a lane object corresponding to the navigation lane as the lane object on which a guiding track object needs to be superimposed and displayed when the result of the deciding is that the lane currently traveled by the vehicle is not the navigation lane.

In some alternative implementations of this embodiment, the superimposition unit 904 includes: a first guiding track position determination subunit (not shown) configured to determine a position of a guiding track corresponding to the guiding track object in the geodetic coordinate system; a second guiding track position determination subunit (not shown) configured to determine position of the guiding track object in the road condition image based on the position and transformation relations among the geodetic coordinate system, a vehicle coordinate system, a camera coordinate system and an image coordinate system; and a rendering subunit (not shown) configured to render the guiding track object on the determined position through texture mapping.

In some alternative implementations of this embodiment, the apparatus 900 further includes: a navigation information generation unit (not shown) configured to generate the navigation information which includes: a navigation route, signs of road sections on the navigation route and lanes corresponding to preset operations on the road sections, the preset operations including: a turn operation and a turning operation.

Referring to FIG. 10, a schematic structural diagram of a computer system adapted to implement the vehicle navigation method of the embodiments of the present application is shown.

As shown in FIG. 10, the computer system 1000 includes a central processing unit (CPU) 1001, which may execute various appropriate actions and processes in accordance with a program stored in a read-only memory (ROM) 1002 or a program loaded into a random access memory (RAM) 1003 from a storage portion 1008. The RAM 1003 also stores various programs and data required by operations of the system 1000. The CPU 1001, the ROM 1002 and the RAM 1003 are connected to each other through a bus 1004. An input/output (I/O) interface 1005 is also connected to the bus 1004.

The following components are connected to the I/O interface 1005: an input portion 1006 including a keyboard, a mouse etc.; an output portion 1007 comprising a cathode ray tube (CRT), a liquid crystal display device (LCD), a speaker etc.; a storage portion 1008 including a hard disk and the like; and a communication portion 1009 comprising a network interface card, such as a LAN card and a modem. The communication portion 1009 performs communication processes via a network, such as the Internet. A driver 1010 is also connected to the I/O interface 1005 as required. A removable medium 1011, such as a magnetic disk, an optical disk, a magneto-optical disk, and a semiconductor memory, may be installed on the driver 1010, to facilitate a computer program read out from the removable medium 1011, and the installation thereof on the storage portion 1008 as needed.

In particular, according to an embodiment of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method of the flow chart. In such an embodiment, the computer program may be downloaded and installed from a network via the communication portion 1009, and/or may be installed from the removable media 1011.

The flowcharts and block diagrams in the figures illustrate architectures, functions and operations that may be implemented according to the system, the method and the computer program product of the various embodiments of the present invention. In this regard, each block in the flowcharts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

In another aspect, some embodiments of the present application further provide a nonvolatile computer readable storage medium. The nonvolatile computer readable storage medium may be the nonvolatile computer readable storage medium included in the apparatus in the above embodiments, or a stand-alone nonvolatile computer readable storage medium which has not been assembled into the apparatus. The nonvolatile computer readable storage medium stores one or more programs. The programs are used by the apparatus to execute the following process: collecting a road condition image through a camera; deciding whether a lane currently traveled by a vehicle is a navigation lane, the navigation lane being a recommended driving lane as defined in navigation information; determining, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and superimposing and displaying the guiding track object on the determined lane object.

The foregoing is a description of some embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A vehicle navigation method comprising:
collecting a road condition image through a camera;
deciding whether a lane currently traveled by a vehicle is a navigation lane, the navigation lane being a recommended driving lane as defined in navigation information;
determining, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and
superimposing and displaying the guiding track object on the determined lane object.

2. The method according to claim 1, wherein the deciding whether a lane currently traveled by a vehicle is a navigation lane comprises:
determining a position of the vehicle;
acquiring, from a high precision map, a position of a lane line of a road section where the vehicle is located;
determining the lane currently traveled by the vehicle based on the position of the vehicle and the position of the lane line; and
deciding whether the lane currently traveled by the vehicle is the navigation lane.

3. The method according to claim 2, wherein the determining the position of the vehicle comprises:
acquiring a GPS coordinate corresponding to the position of the vehicle;
projecting the lane line in the road condition image to the ground;
taking a distance between the lane line projected to the ground and the lane line in the high precision map as a measurement error;
calculating a probability distribution of the position of the vehicle by using a Kalman Filtering algorithm based on the GPS coordinate, the measurement error and a preset vehicle motion model; and
determining a position corresponding to the maximum probability as the position of the vehicle.

4. The method according to claim 3, wherein the projecting the lane line in the road condition image to the ground comprises:
identifying the lane line in the road condition image through machine learning;
extracting the identified lane line; and
projecting the extracted lane line to the ground through sectional straight line fitting.

5. The method according to claim 1, wherein the determining, based on a result of the deciding, the lane object in the road condition image on which the guiding track object is to be superimposed and displayed comprises:
determining a lane object in the road condition image corresponding to the lane traveled by the vehicle as the lane object on which the guiding track object is to be superimposed and displayed when the result of the deciding is that the lane currently traveled by the vehicle is the navigation lane; and
determining a lane object in the road condition image corresponding to the lane traveled by the vehicle and a lane object corresponding to the navigation lane as the lane object on which the guiding track object is to be superimposed and displayed when the result of the deciding is that the lane traveled by the vehicle is not the navigation lane.

6. The method according to claim 5, wherein the superimposing and displaying the guiding track object on the determined lane object comprises:
determining a position of a guiding track corresponding to the guiding track object in a geodetic coordinate system;
determining a position of the guiding track object in the road condition image based on the position of the guiding track in the geodetic coordinate system and transformation relations among the geodetic coordinate system, a vehicle coordinate system, a camera coordinate system and an image coordinate system; and
rendering the guiding track object on the determined position through texture mapping.

7. The method according to claim 6, wherein the method further comprises:
generating the navigation information which comprises: a navigation route, signs of road sections on the navigation route, and lanes on the road sections corresponding to preset operations, wherein the preset operations comprise: a turn operation and a turn-around operation.

8. A vehicle navigation apparatus comprising:
at least one processor; and
a memory storing instructions, which when executed by the at least one processor, cause the at least one processor to perform operations, the operations comprising:
collecting a road condition image through a camera;
deciding whether a lane currently traveled by a vehicle is a navigation lane, the navigation lane being a recommended driving lane as defined in navigation information;
determining, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and
superimposing and displaying the guiding track object on the determined lane object.

9. The apparatus according to claim 8, wherein the deciding whether a lane currently traveled by a vehicle is a navigation lane comprises:
determining a position of the vehicle;
acquiring, from a high precision map, a position of a lane line of a road section where the vehicle is located;
determining the lane currently traveled by the vehicle based on the position of the vehicle and the position of the lane line; and
deciding whether the lane currently traveled by the vehicle is the navigation lane.

10. The apparatus according to claim 9, wherein the determining the position of the vehicle comprises:
acquiring a GPS coordinate corresponding to the position of the vehicle;
projecting a lane line in the road condition image to the ground;
taking a distance between the lane line projected to the ground and the lane line in the high precision map as a measurement error; and
calculating a probability distribution of the position of the vehicle by using a Kalman Filtering algorithm based on the GPS coordinate, the measurement error and a preset vehicle motion model; and determining a position corresponding to the maximum probability as the position of the vehicle.

11. The apparatus according to claim 10, wherein the projecting the lane line in the road condition image to the ground comprises: identifying the lane line in the road condition image through machine learning; extracting the identified lane line; and projecting the extracted lane line to the ground through sectional straight line fitting.

12. The apparatus according to claim 8, wherein the determining, based on a result of the deciding, the lane object in the road condition image on which the guiding track object is to be superimposed and displayed comprises:
determining a lane object in the road condition image corresponding to the lane traveled by the vehicle as the lane object on which the guiding track object is to be superimposed and displayed when the result of the deciding is that the lane currently traveled by the vehicle is the navigation lane; and
determining a lane object in the road condition image corresponding to the lane traveled by the vehicle and a lane object corresponding to the navigation lane as the lane object on which the guiding track object is to be superimposed and displayed when the result of the deciding is that the lane traveled by the vehicle is not the navigation lane.

13. The apparatus according to claim 12, wherein the superimposing and displaying the guiding track object on the determined lane object comprises:
determining a position of a guiding track corresponding to the guiding track object in a geodetic coordinate system;
determining a position of the guiding track object in the road condition image based on the position of the guiding track in the geodetic coordinate system and transformation relations among the geodetic coordinate system, a vehicle coordinate system, a camera coordinate system and an image coordinate system; and
rendering the guiding track object on the determined position through texture mapping.

14. The apparatus according to claim 13, wherein the operations further comprise:
generating the navigation information which comprises: a navigation route, signs of road sections on the navigation route, and lanes on the road sections corresponding to preset operations, wherein the preset operations comprise: a turn operation and a turn-around operation.

15. A non-transitory storage medium storing one or more programs, the one or more programs when executed by an apparatus, causing the apparatus to perform a vehicle navigation method comprising:
collecting a road condition image through a camera;
deciding whether a lane currently traveled by a vehicle is a navigation lane, the navigation lane being a recommended driving lane as defined in navigation information;
determining, based on a result of the deciding, a lane object in the road condition image on which a guiding track object is to be superimposed and displayed, the guiding track object adapted to instruct the vehicle to travel along the lane currently traveled by the vehicle, or to instruct the vehicle to turn to the navigation lane; and
superimposing and displaying the guiding track object on the determined lane object.
